(19) United States
(12) Patent Application Publication
(10) Pub. No.: US 2017/0233122 A1
(43) Pub. Date: Aug. 17, 2017

(54) SYSTEM AND METHOD FOR PREVENTING AND CONTROLLING COMBUSTION AND FLAMMABILITY, OR OXIDATION OF MATERIALS DURING STORAGE OR TRANSPORT

(71) Applicants: Derrel C. THOMAS, Denham Springs, LA (US); Jeffrey GARFINKLE, Baton Rouge, LA (US)

(72) Inventors: Derrel C. THOMAS, Denham Springs, LA (US); Jeffrey GARFINKLE, Baton Rouge, LA (US)

(73) Assignee: PLANK ROAD TECHNOLOGIES, LLC, BATON ROUGE, LA (US)

(21) Appl. No.: 15/501,408

(22) PCT Filed: Aug. 6, 2015
(86) PCT No.: PCT/US2015/043996

§ 371 Date: Feb. 2, 2017

Related U.S. Application Data
(60) Provisional application No. 62/034,607, filed on Aug. 7, 2014.

(51) Int. Cl. B65B 31/04; H01M 2/10; H01M 10/0525; B65B 25/00

(52) U.S. Cl. CPC B65B 31/04; B65B 25/00; H01M 2/1094; H01M 10/0525; H01M 2200/00

(57) ABSTRACT

A system and method for reducing the oxygen content in a storage/transportation device. The system includes a flexible bag type enclosure, a source if inert gas, and a source of vacuum. The enclosure has sealable input and output ports. The system has a vent to the atmosphere. In use, the interior enclosure environment is suctioned down, and re-pressurized with an inert gas. Sever suction/infusion cycles may be necessary, with possible recirculation taking place between or during cycles.

### CROSS REFERENCE TO RELATED APPLICATION

This application claims the benefit under 35 USC 119(e) of Application Ser. No. 62/034,607 filed Aug. 7, 2014, which is incorporated by reference herein in its entirety.

### FIELD OF THE INVENTION

The present invention relates to a system for securing cargo, particularly hazardous cargo, during shipping and/or storage, and methods for preventing and controlling combustion and flammability or degradation of materials or cargo due to oxidation during shipping and/or storage.

### BACKGROUND OF THE INVENTION

Shipping or storage certain cargo (cargo referring to goods transported via ship, aircraft, or motor vehicle) or storage of certain goods, carries with it the inherent risk of fire or combustion due to oxidation. These risks represent potentially devastating resulting damage to the shipping vehicle or storage location within which this cargo is enclosed, as well as to any personnel present at the time such combustibility may occur involving this cargo. For instance, it is known that lithium ion batteries present a fire risk during shipping due to their internal construction. This risk is increased when combined with external factors. Whether due to extreme external heat or an inherent defect within the battery itself, or both factors in combination, an internal short-circuit can occur, leading to a subsequent build-up of internal heat within the battery. When this sequence of events occurs, “thermal runaway” (the point at which the battery has reached an internal temperature that will self accelerate the heat producing reaction, regardless of changes to external environment) may subsequently occur, frequently precipitated by damage to, defects in, or destruction of the extremely thin partition that keep the elements of the battery separated. Once this reaction begins, it will cause the battery to overheat (reaching temperatures often in excess of 470 degrees Celsius) and burst into flames, potentiality igniting surrounding materials and creating further combustion and fire. An additional factor that may aggravate the situation and cause exacerbated combustion hazard is the fact that a lithium battery can release hydrogen during such a thermal runaway. When this occurs, the resulting fire can be catastrophic. As an example, there have been instances during air transport where a fire resulting from such a combustible event has spread so quickly that it has resulted in the inability of the plane crew to contain the flames, leading to the plane crashing—killing the entire crew and destroying all cargo contained within the plane. Other goods also present a combustion threat during shipping and/or storage.

Flaming combustion can be supported if oxygen levels are above the limiting oxygen concentration needed to support such combustion. This oxygen concentration level is known to be approximately 16%. Creating an environment where predetermined, combustion-retarding oxygen levels are maintained is dependent on pressure and temperatures. For instance, the hotter the environment, the less oxygen is required. An internal environment within a gas-tight enclosure can be manipulated to allow oxygen levels to be maintained at low enough levels as to prevent combustible events. Further, in instances such as where internal breaches within lithium ion batteries occur, and where this occurrence inevitably lead to “thermal runaway,” these predetermined and maintained oxygen levels can prevent the spread of such a combustible event from its origin to the surrounding packaging/environs. Instead, and preferably from a damage/danger standpoint, this internal environment can contain this combustible event—keeping flames from proliferating and thus protecting the surrounding packaging/environs and personnel from sustaining damage.

Additionally, stored goods may be subject to oxidation damage, even when combustion is not at issue. For instance, automobiles, voting machines, electronic equipment and components, ammunition, biological and chemical materials, and other goods or materials can suffer oxidation damage, such as rusting when stored for long periods of time. Additional damage that can occur is not oxidation damages, but can be caused by exposure to humidity, acid rain, or other hazard presented by the atmosphere in the storage/transport location (for instance, or military supplies may be stored in a forward deployment location for substantial periods of time, subject to degradation by the ambient atmosphere). A system is needed to reduce the threat of combustion, oxidation, or other deleterious effects present with shipped goods and/or stored goods.

### SUMMARY

One aspect of the invention is a method to seal goods for storage pending later use, or later distribution, in order to protect such goods from oxidation. The preferred system includes a flexible, sealable enclosure, and the system replaces the oxygen rich environment in the interior of the enclosure with an oxygen depleted environment. The preferred enclosure is a flexible enclosure, but a hard sided enclosure may also be utilized.

Another aspect of the invention is to expedite the replacement of the oxygen rich environment with an oxygen depleted environment by first attaching a vacuum pump, other suction device or a recirculation or regenerative blower to the enclosure, and drawing down the internal environment to a lower pressure than the ambient environmental pressure, prior to or while injecting an inert gas or oxygen depleted gas into the interior of the enclosure. In accordance with embodiments of the present invention, the final pressure within the enclosure pressure can be a predetermined absolute pressure that is greater than, less than or equal to a pressure of the external environment; or the pressure can be a predetermined differential pressure with respect to the external environment. In either case, it would be expected that such an internal environment, based on its elemental makeup, would be unsupportive of flaming combustion and greatly reduce the deleterious effects of oxidation.

Another aspect of the invention is a system including a flexible enclosure to encase the cargo in a flexible sealable enclosure, where the enclosure includes an inlet port and/or an outlet port. The system may contain an oxygen and/or pressure sensor to monitor the environment in the interior environment of the enclosure. The system may include valves, an air pump or a vacuum source, a source of inert gas and a controller.

Another aspect of the invention is a recirculation line that connects an inlet port with an outlet port, and a recirculation fan or pump.

In accordance with embodiments of the present invention, the predetermined pressure can be a predetermined absolute pressure that is not equal to a pressure of the external environment, or the predetermined pressure can be a predetermined differential pressure with respect to the external environment.

### BRIEF DESCRIPTION OF THE FIGURES

These and other characteristics of the present invention will be more fully understood by reference to the following detailed description in conjunction with the attached drawings.

FIG. 1 is an illustrative block diagram of one embodiment of the system using 3 way valves.

FIG. 2 is a flow chart depicting one embodiment of the steps of using the system.

FIG. 3 is an illustrative block diagram of another embodiment of the system using solenoid valves.

FIG. 4 is a illustrative diagram of one embodiment of the enclosure having a single sealable access opening.

### DETAILED DESCRIPTION

In accordance with embodiments of the present invention, a flexible cargo enclosure preferably is used to completely enclose and contain cargo 1000 within the interior, where the internal environment of the enclosure can be substantially isolated from the exterior external environment. The internal environment will be configured as an oxygen depleted environment, with the enclosure constructed in a gas-tight manner to maintain the determined oxygen levels within the internal environment.

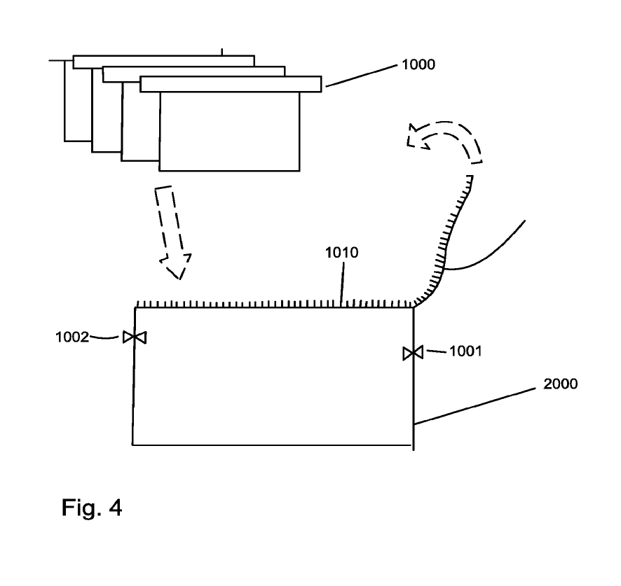

In one embodiment, the enclosure 2000 is manufactured using a flexible puncture resistant, gas tight fabric (such as a coated woven nylon, polyethylene, polypropylene, polyurethane or other puncture resistant polymer material, such as polyamides). The enclosure 1000, has a sealable access opening 1010. As shown in the embodiment of FIG. 4, the access opening 1010 allows for loading of materials into the interior of the enclosure (a generally flexible bag). The access opening is sealingly closable, such as a suitable zipper, slide zipper or other reusable closure device. The enclosure, when closed, is substantially impermeable to fluids (a gas or a liquid), thereby allowing the interior environment to be isolated from the exterior environment. The enclosure should be capable of holding a reduced pressure or increased pressure environment within the enclosure interior. For instance, the enclosure may include a lining material (such as a separate polyurethane or polyethylene liner or film applied to or laminated to the interior of the outer enclosure), to further isolate and seal the “interior environment” (i.e., the environment interior the liner material) from the exterior environment.

In a preferred embodiment, the enclosure is sized to rest on a unit load device (ULD) or pallet, (or to contain the ULD or pallet in the interior of the enclosure, not preferred) and to contain goods in the enclosure interior. However, the scope of the inventions is not so limited, and may be used with non-palletized goods (for instance, an automobile may be driven onto a suitable enclosure at the desired storage location). To load and unload goods into the enclosure interior, the enclosure also includes a sealable access opening, 1010 such as an airtight zippered opening that allows a user to open the enclosure to load or unload cargo. The access opening may completely surround the enclosure, such that when opened, the enclosure is in two separate pieces, or may simply create an opening in the enclosure suitable for loading cargo into the interior of the enclosure, such as shown in FIG. 4. For a hard sided enclosure, the opening may be a closable door or similar entry.

The enclosure preferably should have at least one sealable closable inlet opening 1001, and a sealable closable discharge or outlet opening 1002. Each opening preferably can be sealed with a suitable valve, such as a check valve, fill valve, gate valve, ball valve, solenoid valve, Boston valve, poppet valve or other suitable valve. The inlet opening and outlet opening can be the same opening (for instance by using nested pipes to connect to the single opening, which operationally can function as two openings), but this is not preferred, particularly if a recirculation system is to be included in the system. Any seams in the enclosure should also be airtight, such as seams created via RF welding, heat sealing or hot air or hot gas welding, laser welding or other technique to sealing join fabrics (for a softsided or flexible enclosure). The body can comprise a single continuous piece of material, or two or more pieces of material coupled together. One suitable enclosure is the Freight Glove manufactured by Sentina, Inc, a New York Company, which is described in U.S. Pat. No. 8,278,617 hereby incorporated by reference. The system can be configured with a single port, which operates both as the inlet and an outlet port, but this is not preferred, as recirculation is difficult to achieve.

The outlet or discharge port is configured to be coupled to a vacuum or suction, or to a reduced pressure environment (the vacuum suction source can also be created by a pump or blower/fan type device). The suction source, when coupled to the discharge or outlet port will partially remove the interior gases thereby creating a reduced pressure environment in the enclosure interior. The packaging of the cargo may present a limit on how low the interior pressure can be driven, as cargo packaging or cargo internal voids may collapse if the pressure internal to the enclosure is drawn too low. Additionally, the compressibility of the enclosed cargo may limit the extent of “negative” pressure. One or more pressure sensors can be utilized to monitor the interior pressure, or the applied pressure, or the pressures in the discharge hoses coupled to outlet. Instead of measuring pressure differential, the absolute pressure may be measured also.

In one embodiment of the invention, one or more recirculation lines may be provided, each coupling two ports or opening on the enclosure (such as coupling an inlet port to an outlet port). The recirculation line does not have to be a singular, dedicated line. For instance, the recirculation line may connect to three way valves located on or associated with the inlet and outlet ports. A fan or air pump may be included in the recirculation line or associated with a portion of the recirculation line (or on the valves), thereby providing a flow of fluid through the enclosure from the inlet to the outlet via the recirculation line. The use of recirculation results in a mixing of the internal environment. Recirculation can be ongoing during transportation or storage, but this is not preferred.

The enclosure system may include an oxygen sensor positioned with the sensor detecting the oxygen content in the interior environment, such as detecting oxygen partial pressure. Typical oxygen sensors include galvanic cell sensors, polarographic sensors, and optical sensors, but any oxygen sensor with suitable accuracy can be used. The oxygen sensor may be located near the inlet, the outlet, in the recirculation line (if present) or elsewhere in the interior of the enclosure or in some line in the system, such as in one of the hoses, or at a controller, if used in the system. An oxygen sensor may also sealably extend through the enclosure itself, with the sensing end positioned in the interior space to allow for continued monitoring of the oxygen content in the interior of the enclosure during storage or transport. As an alternative to an oxygen sensor, the sensor may detect the inert gas, for instance, a nitrogen or carbon dioxide sensor (where the sensor readings can be converted to percent of gas by volume, or partial pressure, or other characteristic that can be related to the ability of the interior atmosphere to prevent oxidation, and/or ignition and flammable combustion.

The bottom of the enclosure (as well as the sides) can be lined with a heat insulator to protect the enclosure itself from non-combustion heat events, such as exothermic chemical reactions, to prevent melting of the enclosure wall and possible breach, when there is a possibility of this risk. Additionally, the enclosure system may include a puncture resistant (preferably an air permeable cover or shroud), to partially cover or “shroud” the cargo. One suitable material is a non-woven polypropylene flexible geotextile fabric. Alternatively, the puncture resistant material may form a separate layer of a multilayer constructed flexible forming the flexible enclosure, such as the innermost layer, or a layer adjacent to an heat insulation fabric layer, such as a silica fabric.

To use the system, the enclosure access opening is opened, and cargo is stored or loaded within the interior space of the enclosure, such as onto an insulator located in the interior, if used in the system. If a separate puncture resistant shroud is part of the enclosure system, the cargo (or a portion of the cargo), may be covered or partially covered with the puncture resistant shroud. The enclosure access opening is then closed, with the enclosure loaded with cargo in the enclosure interior.

Preferably, with all ports or openings sealed, the outlet port is opened, and a suction is applied to the outlet port, withdrawing the ambient internal oxygen rich atmosphere and reducing the air pressure in the internal environment (an evacuation or vacuum or purge step). Suction may be applied for a period of time so as to deplete the oxygen level. Suction may cease once a set period of time, or a set internal pressure is achieved, or when the interior environment oxygen content reaches a desired first level. Once a suitable internal pressure or environment is achieved, the suction can be interrupted for a period of time with the other ports closed. This allows a user to verify that the internal reduced pressure is being maintained, an indicator of the integrity of the enclosure. This time period also allows time for oxygen, within the cargo volume or in the cargo packaging enclosed within the unit, to migrate out of the cargo or cargo packaging, making it accessible to subsequent removal.

A source of inert gas (gas that does not support combustion), such as nitrogen, carbon dioxide, argon, helium, or mixtures thereof, or other inert gases, is connected to the inlet port. Inert gas is allowed to flow into the interior through the inlet port (a fill or flow step). The outlet port may be closed or initially opened (with or without applied suction) while the inert gas flows into the interior. Again, the inlet and outlet may be the same port. The outlet port, if opened, is then closed, and inert gas may continue flowing into the interior, thereby raising the pressure in the interior environment. Preferably, when the interior pressure reaches a predetermined first value, or after a period of time, or after injection of a predetermined volume of gas, or when the oxygen content in the interior reaches a second reduced level, or the inert gas content reaches a desired level, the flow of inert gas into the interior stops.

If the system is equipped with a recirculation line, the recirculation line can be opened to the internal atmosphere, allowing the recirculation fan or pump to circulate and mix the internal environment. Such mixing ensures that oxygen readings from the oxygen sensor are representative of the interior, and not a local environment reading. Recirculation can be done concurrently with infusion of inert gases, or after the infusion of inert gases, or a combination.

Evacuation and fill steps can be repeated several times, with or without recirculation being employed. As gaseous oxygen can be contained in the packaging of the cargo, drawing out this oxygen can take several iterations of evacuation and fill. Preferably, the interior environment should have oxygen levels less than 17%, preferably less than 15%, more preferably, less than 12%, more preferred, less than 10% by volume (such as 8%).

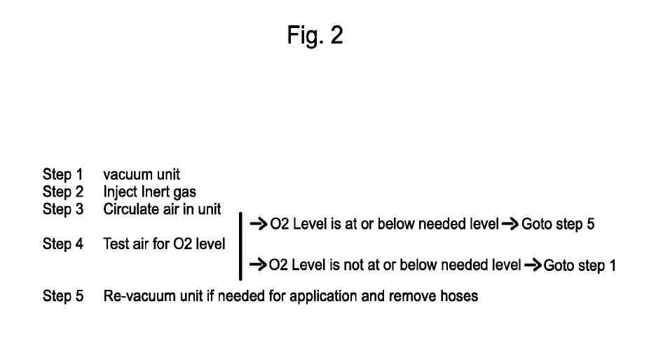

The enclosure system may be partially automated, with a processor or programmable control module receiving inputs from the systems sensors, such as an oxygen sensor, pressure sensors, and other desired sensors (such as temperature sensors). In an automated environment, the inlet and outlet valves may be computer controlled (using for instance solenoid control valves attached to the ports), with the processor cycling the system through the evacuation and fill stages based on the readings from the sensors. One flow depiction on such automated sequence is shown in FIG. 2. One skilled in the art can appreciate that one or more of the steps of FIG. 2 can be performed simultaneously and/or in a different order than as shown in FIG. 2.

At the completion of an exhaust or purge sequence, followed by an infusion sequence(s) or cycle, the interior of the enclosure will comprise an oxygen reduced environment. The internal pressure desired at the completion can be ambient atmosphere pressure, less than ambient, or greater than ambient (where ambient is the local pressure where the exhaust/fill steps are undertaken). The desired final pressures may be dependent on the mode of shipping and the product shipped. For instance, during air transport, the interior pressure will change depending on the surrounding external pressure. It may be desired to have the enclosure interior pressure at a pressure greater then, or less than a set pressure to account for the changes in the ambient exterior pressure during transport.

Given the low level of oxygen needed, an 800 ft³ enclosure may take 10-30 minutes or less to reach desired oxygen levels using a small suction source. These times can be varied based on the degree of suction or applied negative pressure utilized, the speed with which inert gasses are allowed to flow into the enclosure, and the fill factor (e.g. what volume of air the solid pieces displace) of the cargo.

Once the oxygen levels are at the predetermined desired levels, there is insufficient oxygen to support flammable combustion and create a fire hazard, or the speed of oxidation will be greatly reduced. The system has been tested using lithium ion batteries as the flame source. In the tests, the enclosure internal environment had oxygen levels dropped using several exhaust/fill sequences until the oxygen content was around 12% by volume. A heater, located under the lithium ion batteries, began to apply heat to the batteries. The heater raised battery temperature in excess of 300-400 degrees Fahrenheit. As a result of the heat, the 18650 type lithium ion batteries began to malfunction and break down, generating their own internal heat and moving into thermal runaway. The malfunctioning batteries began to glow white hot, and reached temperatures in excess of 700 degrees Fahrenheit. In some instances, the batteries exploded. However, flames were not initiated. In several experiments, the batteries were resting on flammable cardboard, and the cardboard did not ignite. The experiments were conducted with single batteries, and multiple batteries in the enclosure to simulate shipping conditions. In all instances, the risks of flammable combustion were contained.

Given the heat generated by a malfunctioning battery, a heat insulator or insulating blanket may be used to surround or partially surround the cargo to protect the enclosure itself from exposure to heat in excess of the enclosure material melting temperature or liner melting temperature (for instance, type 6,6 nylon melts at 255-265° C. (490-510° F.)). Also, a puncture resistant shroud may be used to cover the batteries or other cargo, to protect the integrity of the enclosure from damage that may be caused by a hot exploding lithium ion battery (or other cargo). The shroud and insulator may be combined, or dispensed with. The enclosure system may also include a communications system, where sensor readings may be communicated to an outside location or system. For instance, if the sensors provide a visual indicator, the communications system may simply be a window in the enclosure where the sensors visual indicator may be viewed. The communications can be radio communications (such as blue tooth enabled communications, WIFI or wireless or cellular communications, or communications satellite network to a remote terminal). The radio communications can be directed to a radio receptor located exterior to the enclosure, such as attached to the exterior of the enclosure (for further communications or a visual indicator of the readings), or located at a cargo monitor station, such as aboard the transport vehicle or in the storage location, or to a remote monitoring station. The receptor may interface (wired or wirelessly) to an alarm system to provide an alarm indicator if sensor readings fall outside a specified range, thus indicating a malfunctioning enclosure system, (e.g., pressure change, elevated oxygen levels), or other conditions that may require investigation (such as rapidly rising temperatures in the enclosure interior).

The sensors may be in communication with a monitoring system, such as a processor or a programmable logic controller. The monitoring system can be configured to automatically and continuously or periodically record the sensor readings, and to communicate the recorded readings periodically, or on an interrogation from a user.

The enclosure can be a sealable flexible enclosure having a shape and size that is suitable for the contents intended to be enclosed and contained. The enclosure can have a body with a generally rectangular shape and which includes a flap or opening that can be fastened and/or sealed as the access opening in the enclosure, where the opening can be sealed closed, such as with an air tight zipper manufactured by the YKK corporation. One skilled in the art will appreciate that the present invention is not limited to any of these specific selections in shape or number of pieces of material of the security enclosure 100.

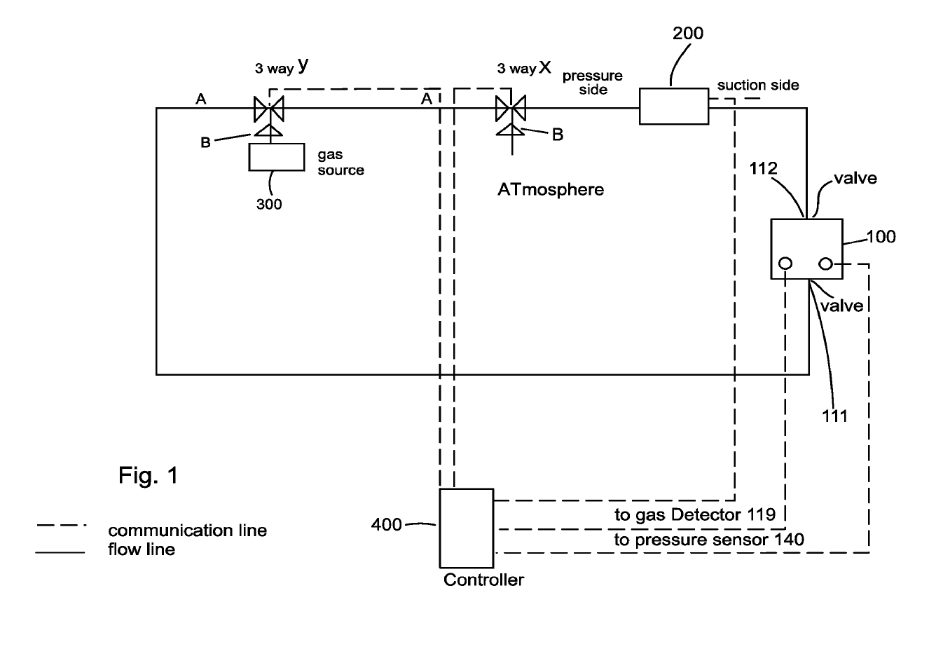

As shown in FIG. 1, the enclosure 100 includes a body and a sealable inlet port 111 (sealed for instance, with a valve) disposed on and through the body and a sealable outlet port 112 (sealed, for instance with a valve). For example, the sealable ports can include a rubber flange, a hinge, and a hatch having a handle configured to rotatably open and close a fluid tight seal, such as a fill valve or check valve. Traditional valves may be located in or at the ports, such as check valves, ball valves, gate valves, etc. The outlet port 112 communicates with a recirculation blower 200 (or an air pump or other source of vacuum or suction) on the suction side of the blower, while the inlet port 111 of the enclosure communicates with three way valve Y. Three way valve Y has two paths connecting the valve inlet to output Position A or Position B. Position B communicates with a source of inert gas, while position A communicates with position A on three way valve X. Position B on three-way valve X communicates to the atmosphere.

The outlet side of the blower 200 communicates with the inlet of three-way valve X. As shown, the inlet 111 and outlet port 112 of the enclosure 100 may have separate valves that will remain on the enclosure after other system equipment is removed.

Also shown is a gas detector 119 (such as an oxygen or inert gas detector), shown positioned in the inlet port or near the inlet port 111 of the enclosure. A gas detector can be located elsewhere, such as in the outlet of the recirculation pump, the inlet of the 3-way valve x, or elsewhere in the system. The location of the blower, gas source and vent to atmosphere within the flow can vary, and are only exemplary in FIG. 1.

Finally, controller 400 is shown, which receives input from the gas detector 119, and preferably pressure detector 140 which may be used to control the three-way valves such as solenoid valve (if they can be remotely actuated). Controller 400 may also communicate with a pressure detector 140 located in the interior of the enclosure (not shown) or the controller may include a pressure detector that is in communication with the interior of the enclosure (not shown). Controller can be a programmable logic controller or programmable computer.

As shown, to use the system, cargo is loaded in the enclosure and the enclosure is sealed. Inlet and outlet valves on the enclosure are then opened.

### Vacuum or Purge Interior

To reduce the interior pressure (to suction the atmosphere from the interior of the enclosure), Valve X is placed in position B, and Value Y can be placed in either position A or B, or alternatively, the inlet valve may be closed. The reciprocation blower 200 is activated, which places suction on the outlet port, pulling the atmosphere out of the enclosure interior, and venting (through Valve X) to the atmosphere. A source of vacuum, as used herein can be a pump, fan, or other suction type device having a high pressure side and a low pressure side.

If the inlet valve is opened, and Valve Y is in position B, this is equivalent to the inlet valve being closed. If Valve Y is in position A, then as a suction is draw in, inert gas flows into the interior of the enclosure, combining the steps of applying a suction (vacuuming the interior) and flowing inert gas.

### Flowing Inert Gas

To flow inert gas into the interior of the enclosures, the inlet valve is opened, and Valve Y is placed in position B. If the source of gas is pressurized, the outlet valve may be opened or closed. If the outlet valve is opened, then valve X may be placed in position B. In this configuration, gas flows into the interior of the enclosure, travels through the blower (which may or may not be used in this step), and the gas then vents to the atmosphere. In this configuration, the flowing gas acts like a gas fluid wash, pushing out the existing atmosphere in the interior of the enclosure and replacing that atmosphere with the inert gas. As such, this step may be used in lieu of the suction steps. At some point during this step, the outlet valve may be closed to pressurize the interior with the inert gas (preferred).

### Recirculating or Mixing

To recirculate, Valve X and Valve Y are placed in position A, the inlet and outlet valves at the enclosure are opened, and the blower is activated. Gas exits the interior of the container through the outlet, though the blower and to Valve X, thence to Valve Y, and back to the interior of the enclosure via the inlet.

### Control

The opening and closing of the valves and the activation of the blower can be controlled by the Controller 400, operating under a set sequence of steps, where the transition between one step and the next can be based on time, pressure readings, gas detector readings (partial pressure or otherwise), or a combination.

### Sequence of Steps

One sequence of steps is charted in FIG. 2. However, this sequence of steps is illustrative, and the inventions should not be so limited. As shown, once cargo is loaded in the interior, the interior is vacuumed, and then a source of inert gas is activated (vacuuming and flowing inert gas may be partially combined) and flowed into the interior. Next, the interior may be circulated (recirculation step) to mix the interior atmosphere. The recirculation step may be dispensed within certain embodiments. The atmosphere is tested for O2 levels (or inert gas levels), and if sufficient, the interior pressure may be set to the desired value by flowing additional inert gases into the interior (not shown), or additional vacuuming. If the O2 levels are undesirably high, some or all of the steps may be repeated. (e.g. vacuum, flow, recirculate), after which, the O2 levels can again be checked.

Once the proper internal atmosphere is established, the connecting lines, 3-way or solenoid valves, gas source and recirculation pump can be disconnected from the enclosure and removed, as this equipment will not normally be used during transport. Alternatively, the equipment (some or all) may be maintained with the enclosure during transport.

With a single port embodiment, a three or four way valve may be connected to the single port to connect the gas source and vacuum pump to the port, and the sequence can be as specified above (without recirculation steps). Alternatively, the pump and gas source may be sequentially coupled to the single port as needed.

Additionally or alternatively, the system can include one or more communications systems (not shown). The communications systems can include one or more communications devices, which can be disposed within, through, or used in conjunction with the enclosure and/or on the enclosure 100, for example within, through, and/or on the body 110 of the enclosure 100. The communications device can include one or more wireless transmitters, transceivers, receivers, and other wireless communications devices. The communications device may be in communication with one or more of the sensors that are provided in the system including any environmental sensor such as a pressure sensor, temperature or gas sensor. The communications system may additionally include a receiving component, which can be any suitable receiver, transceiver, computer workstation, other computing system, and any other wireless or other communications device or communications network suitable for receiving a signal transmitted from the communications device.

One or more additional hardware components may be included in the communications system or controller, such as a processor, memory, and programmable logic devices. The hardware components may be in communication with the communications device to enable further desired functionality. By way of example, a processor and memory can be included for storing/buffering sensor data.

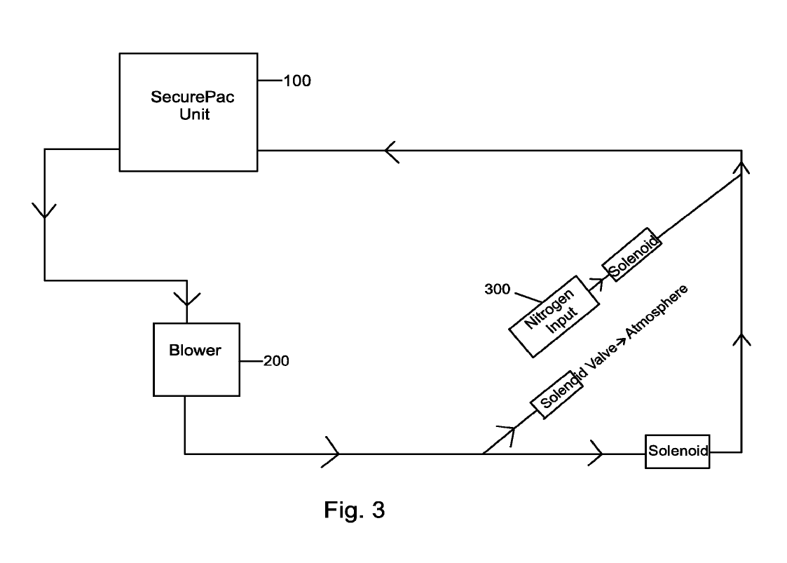

Another flow diagram showing the system's components is shown in FIG. 3 where solenoid valves are used instead of three way valve. In this figure, the controller and sensors (pressure and gas sensor) are not shown, but would normally be present in the system. Again, the location of the various components can vary.

One sequence of steps for using the system (under the control of the controller, is as follows:
Load enclosure
Close and seal enclosure
Connect system equipment
Start controller
Controller does the following
(1) Set up to Vacuum (open outlet port, open vent to atmosphere),
(2) vacuum (start blower) until desired constraint reached (time, pressure achieved, gas level, etc.)
(3) recirculate (optional) (open inlet, outlet, close vent to atmosphere, close gas source)
(4) check internal O2 level (or level of inert gas—read sensor)—if at desired level, go to step 9 or 10 (alternatively, check for desired internal pressure)
(5) Set up to inject gas (open inlet and outlet, open gas source, close vent to atmosphere)
(6) gas injection until desired constraint reached (time, pressure levels, gas level, inject a designated volume)
(7) recirculate—optional
(8) check internal O2 level (or inert gas level)—if good, go to step 9 or 10, if bad, go to step (1)
(9) Optional—set pressure in enclosure to desired storage or transportation pressure (either vacuum or inject gas)
(10) close inlet/outlet valves, remove equipment.

Numerous modifications and alternative embodiments of the present invention will be apparent to those skilled in the art in view of the foregoing description. Accordingly, this description is to be construed as illustrative only. Details of the structure may vary substantially without departing from the spirit of the present invention.

1. A system comprising a flexible sealable enclosure comprising a sidewall and an access opening, and a port through said sidewall; a source of vacuum connected to the port, and an inert gas source connected to the port.

2. A system comprising a flexible sealable enclosure comprising a sidewall, a sealable input port and a sealable outlet port through said sidewall; a source of vacuum connected to the output port, a source of inert gas connected to the input port and further comprising a recirculation line connecting said input port to said output port and at least two valves connecting said source of vacuum, said source of inert gas, and said recirculation line.

3. The system of claim 1 further having a thermal insulator positioned in the interior of the enclosure.

4. A method of storing a material comprising the steps of
a) storing the material in the interior of a flexible enclosure having a sealable port;
b) applying a vacuum source to said port to partially withdraw the atmosphere in the interior of the enclosure; and
c) flowing an inert gas into the interior of the enclosures via the port.

5. The method of claim 4 further comprising the steps of repeating steps (b) and (c).

6. A method of storing material comprising the steps of
a) storing the material in the interior of a flexible enclosure having a sealable input port and a sealable outlet port;
b) applying a suction to said sealable outlet port to partially withdraw the atmosphere in the interior of the enclosure;
c) flowing an inert gas into said interior of the enclosure through said sealable input port; and
d) determining the level of a predetermined gas in the atmosphere interior of said enclosure.

7. The method of claim 6 further comprising the steps of performing steps (b) and (c) at least partially simultaneously.

8. The method of claim 6 further comprising the steps of repeating steps (b)-(c) if the levels of said predetermined gas is outside a desired range.

9. The method of claim 6 further comprising the steps of sealing said input and output ports, and transporting said cargo in said sealed flexible enclosure.

10. The method of claim 4 wherein steps (b) and (c) are performed partially at the same time.

11. The system of claim 1 further comprising at least one lithium battery positioned in the interior of the enclosure.

12. The method of claim 4 wherein said suction source is disconnected from said port before said inert gas is flow into the interior of the enclosure.

13. The method of claim 4 wherein said suction source is not disconnected from said port before inert gas is flowed into the interior of the enclosure.

14. The method of claim 6 further comprising recirculating the atmosphere interior to said enclosure.

15. The method of claim 14 wherein recirculation step is performed after said step (c).

16. The system of claim 2 further comprising a gas sensor in fluid communication with one of said input or output ports and for sensing gases with the interior of said enclosure.

17. The system of claim 2 further having a thermal insulator positioned in the interior of the enclosure.

18. The system of claim 2 further comprising at least one lithium battery positioned in the interior of the enclosure.
